(19) United States
(12) Patent Application Publication
(10) Pub. No.: US 2023/0133272 A1
(43) Pub. Date: May 4, 2023

(54) INTELLIGENT DEVICE, AND SYSTEM AND METHOD FOR COMMUNICATION BETWEEN AP COMPONENT AND WCN COMPONENT THEREOF

(71) Applicant: SPREADTRUM COMMUNICATIONS (SHANGHAI) CO., LTD., Shanghai (CN)

(72) Inventor: Chao MENG, Shanghai (CN)

(21) Appl. No.: 18/148,090

(22) Filed: Dec. 29, 2022

Related U.S. Application Data
(63) Continuation-in-part of application No. PCT/CN2021/088892, filed on Apr. 22, 2021.
Application No. PCT/CN2021/088892 is a continuation-in-part of application No. PCT/CN2021/088908, filed on Apr. 22, 2021.

(30) Foreign Application Priority Data
Jun. 30, 2020 (CN) 202010620806.6
Jun. 30, 2020 (CN) 202010622940.X

(51) Int. Cl. G06F 9/445; G06F 9/54

(52) U.S. Cl. CPC G06F 9/44505; G06F 9/545

(57) ABSTRACT

An intelligent device, and a system and a method for communication between an AP component and a WCN component of the intelligent device are provided. The WCN component includes at least one wireless communication functional component. The AP component includes a system layer and a kernel layer. The kernel layer includes at least one device node respectively corresponding to the at least one wireless communication function component. The kernel layer further includes a WCN communication component. The system layer is configured to invoke the WCN communication component through an API, to control the WCN communication component to periodically perform read and write operations on the device node to monitor a state of the WCN component.

### CROSS-REFERENCE TO RELATED APPLICATIONS

This application is a continuation-in-part application of International Application No. PCT/CN2021/088892, titled “SMART DEVICE AND COMMUNICATION SYSTEM AND METHOD FOR AP MODULE AND WCN MODULE THEREOF”, filed on Apr. 22, 2021, which claims priority to Chinese Patent Application No. 202010622940.X, filed on Jun. 30, 2020, and this application is also a continuation-in-part application of International Application No. PCT/CN2021/088908, titled “SMART DEVICE AND WCN MODULE EXCEPTION RECOVERY SYSTEM THEREOF AND METHOD THEREFOR”, filed on Apr. 22, 2021, which claims priority to Chinese Patent Application No. 202010620806.6, filed on Jun. 30, 2020, all of which are incorporated herein by reference in their entireties.

### FIELD

The present disclosure relates to the technical field of wireless communications, and in particular relates to an intelligent device, and a system and a method for communication between an AP (application processor) component and a WCN (wireless communication network) component of the intelligent device.

### BACKGROUND

In order to meet the increasing requirements for intelligent society, more and more intelligent devices run intelligent operating systems having abundant peripheral components, instead of simple systems used in single-chip microcomputers in the past. An intelligent device with a wireless communication function normally includes an AP component and a WCN component. The AP component is configured to run an intelligent operating system such as Android or Linux. The WCN component is configured to provide at least one wireless communication function, such as a Wi-Fi (wireless Internet access) function, a Bluetooth function, an FM (frequency modulation) function, and a GPS (Global Positioning System) function. The application framework or application programs (such as tools and settings) in the intelligent operating system at the AP side are required to communicate with the WCN component to obtain information related to the WCN component. That is, in addition to performing normal functions, the intelligent operating system communicates with the WCN component to perform basic information interaction (including information acquisition and setting) and monitor an operating state of the WCN component, which includes but is not limited to:

1) obtaining a driver version and a firmware version of the WCN component;

2) obtaining and setting an on-off state and a level of an output log of the WCN component;

3) obtaining and setting an operating mode and an operating time of the WCN component; and

4) monitoring an operating state of the WCN component.

It is difficult for a general intelligent operating system framework to define a unified interface and communication manner for implementing the above functions with different WCN components. In addition, limited by some security designs, Android and other intelligent operating systems cannot directly communicate with the WCN component. For example, in Android OS 8.0 and subsequent versions, the HAL (Hardware Abstraction Layer) at the AP side belongs to a system partition, and the WCN component belongs to a vendor partition, where the system partition and the vendor partition cannot directly communicate with each other.

### SUMMARY

A system for communication between an AP component and a WCN component is provided according to the present disclosure, which is applied in an intelligent device. The WCN component includes at least one wireless communication functional component. The AP component includes a system layer and a kernel layer. The kernel layer includes at least one device node respectively corresponding to the at least one wireless communication functional component. The kernel layer further includes a WCN communication component. The system layer invokes the WCN communication component through an API (application program interface), to control the WCN communication component to periodically perform read and write operations on the device node to monitor a state of the WCN component.

### BRIEF DESCRIPTION OF THE DRAWINGS

FIG. 1 is a schematic architecture diagram of a system for communication between an AP component and a WCN component of a conventional intelligent device.

FIG. 2 is a schematic architecture diagram of a system for communication between an AP component and a WCN component according to an embodiment of the present disclosure.

FIG. 3 is a schematic architecture diagram of a system for communication between an AP component and a WCN component according to an embodiment of the present disclosure.

FIG. 4 is an architecture diagram of a system for recovering from an abnormality of a WCN component of an intelligent device according to an embodiment of the present disclosure.

FIG. 5 is a flowchart of a method for communication between an AP component and a WCN component according to an embodiment of the present disclosure.

FIG. 6 is a flowchart of a method for recovering from an abnormality of a WCN component of an intelligent device according to an embodiment of the present disclosure.

### DETAILED DESCRIPTION OF THE EMBODIMENTS

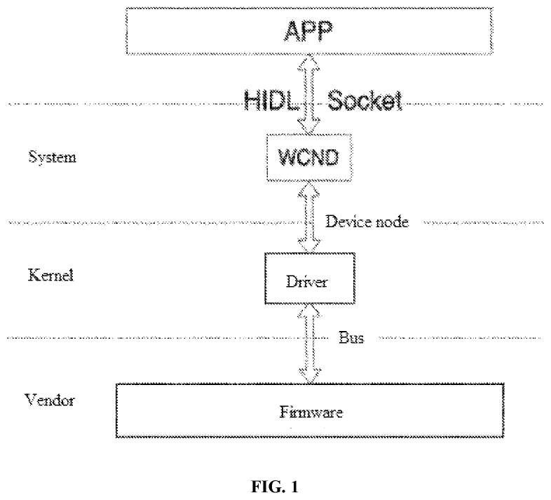

FIG. 1 is an architecture diagram of a system for communication between an AP component and a WCN component of a conventional intelligent device. A system partition component WCND (WCN Debugging) is added to the general intelligent operating system architecture. The bidirectional communication between an APP (application program) and the WCND may be implemented by using HIDL (HAL interface definition used by Android) or Socket (socket used by Linux and other operating systems). The APP includes tools, setting or the like. The kernel creates fixed device nodes dedicated to respective wireless communication functions. The WCND component communicates with the kernel by accessing the device nodes in the kernel layer. Specifically, the WCND component may write data into the fixed device nodes, the kernel reads the data and updates contents in the device nodes based on communicated contents, and then the WCND read out the updated contents, thereby completing a communication. A driver component communicates with a firmware through a bus for different WCN sub-components.

The technical solutions of present disclosure are described hereinafter with reference to embodiments but are not limited to the embodiments.

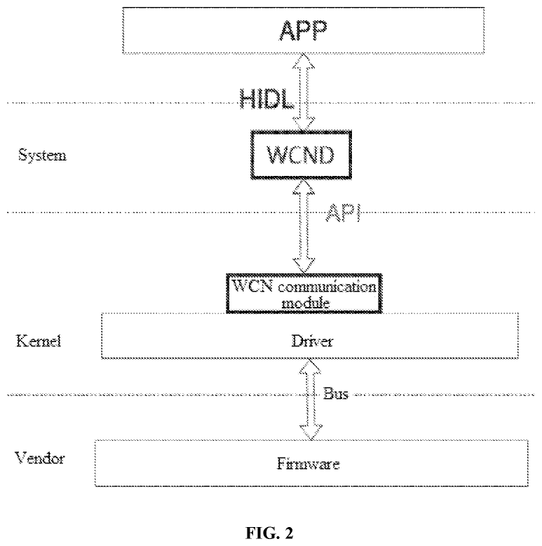

As shown in FIG. 2, a system for communication between an AP component and a WCN component is provided according to an embodiment of the present disclosure. The system is applied in an intelligent device which is an intelligent phone using an Android system. The WCN component includes four wireless communication functional components, namely a Wi-Fi component, a Bluetooth component, an FM component, and a GPS component. In other embodiments, the WCN component may only include one or more of the above four components. FIG. 2 shows an improved architecture based on the general Android system architecture. The system layer includes an APP and a WCND. The bidirectional communication between the APP and the WCND is implemented through HIDL. The kernel layer includes a driver component, which is represented by “Driver” in FIG. 2, and the WCN component is represented by the “Firmware” in FIG. 2. The “Driver” and the “Firmware” communicate with each other through a bus. The kernel layer further includes four device nodes (not shown in the figure) respectively corresponding to the Wi-Fi component, the Bluetooth component, the FM component, and the GPS component.

In some embodiments, the AP component includes a system layer and a kernel layer. In addition to the device nodes respectively corresponding to the wireless communication functional components, a WCN communication component is added in the kernel layer. The WCN communication component is a dynamic library accessible by an external device through an API, and is a new component added to the conventional implementation. The system layer invokes the WCN communication component through an API, to control the WCN communication component to periodically perform read and write operations on the device nodes, to monitor a state of the WCN component.

In some embodiments, the system layer further invokes the WCN communication component through the API, to control the WCN communication component to read data from the device nodes to obtain at least one of a driver version, a firmware version, an operating mode, an operating time, a current log level, and a log on-off state of the WCN component, and control the WCN communication component to perform a write operation on the device nodes to set at least one of the log level, the log on-off state, the operating mode, and the operating time of the WCN component.

In some embodiments, the WCN debugging component in the system layer invokes the WCN communication component through the API. The WCN debugging component is further configured to transparently transmit result data of the invoking to the APP layer.

In the embodiments, the conventional WCN debugging component is split and decoupled, so that a function highly related to the communication of the WCN component, i.e., the function of the WCN communication component, is arranged into the lower kernel layer, and an API is provided for invoking by the upper system layer at the AP side. The system layer only invokes the WCN communication component through the API to request monitoring the state of the WCN component. The read access and write access to the device nodes respectively corresponding to the wireless communication functional components are performed by the WCN communication component in the kernel layer, rather than being performed by the cross-component system layer. In this way, the vendor partition component is independent from the system partition component, thereby avoiding cross-component access and preventing the device nodes in the kernel level from being exposed to the outside. The system partition component no longer accesses the vendor partition component through exposed channels, thereby improving the security of the system. Since the WCN communication component and the device nodes are all in the kernel layer, memory access at the AP side is greatly reduced. Compared with cross-component access to the device nodes, the above embodiments can improve communication efficiency and avoid communication congestion.

With the above embodiments, the communication function required by the system layer to monitor the state of the WCN component is realized, and the system layer can acquire and set information related to the WCN component by invoking the WCN communication component. In the above embodiments, the WCN communication component serves as a dynamic library having an interface for invoking by the WCND at the system layer to communicate with the WCN component. This communication method is simpler than the conventional communication method that the WCN debugging component accesses the device nodes in the kernel layer in a cross-component manner. The framework of the above embodiments is simple and clear, reducing unnecessary intermediate layers, improving communication efficiency, and having a good expansibility. For expansion, it is only required to update an API interface function, which also facilitates transplanting.

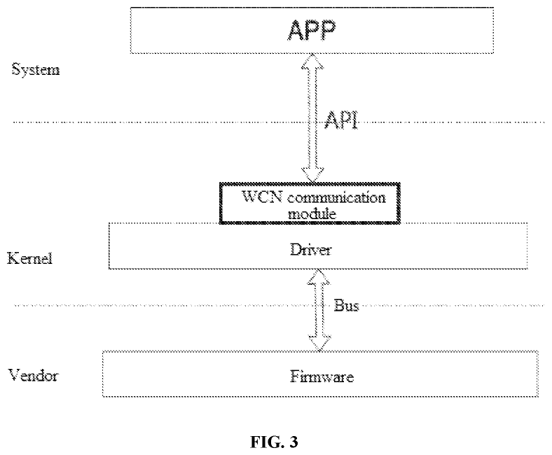

As shown in FIG. 3, a system for communication between an AP component and a WCN component is provided according to an embodiment of the present disclosure, which is applied in an intelligent device. The difference between the embodiment shown in FIG. 3 and the embodiment shown in FIG. 2 lies in that the operating system of the intelligent device is a non-Android embedded system, specifically Ubuntu. Since Ubuntu has a simpler framework, the WCN debugging component is not required, and the APP included in the system layer directly invokes the WCN communication component through an API.

In the embodiment, the conventional WCN debugging component is split and decoupled, so that a function highly related to the communication of the WCN component, i.e., the function of the WCN communication component, is arranged into the lower kernel layer, and an API is provided for invoking by the upper system layer at the AP side. The system layer only invokes the WCN communication component through the API to request monitoring the state of the WCN component. The read access and write access to the device nodes respectively corresponding to the wireless communication functional components are performed by the WCN communication component in the kernel layer, rather than being performed by the cross-component system layer. In this way, the vendor partition component is independent from the system partition component, thereby avoiding cross-component access and preventing the device nodes in the kernel level from being exposed to the outside. The system partition component no longer accesses the vendor partition component through exposed channels, thereby improving the security of the system. Since the WCN communication component and the device nodes are all in the kernel layer, memory access at the AP side is greatly reduced. Compared with cross-component access to the device nodes, the above embodiment can improve communication efficiency and avoid communication congestion.

With the above embodiments, the communication function required by the system layer to monitor the state of the WCN component is realized, and the system layer can acquire and set information related to the WCN component by invoking the WCN communication component. In the above embodiments, the WCN communication component serves as a dynamic library having an interface for the WCND at the system layer to invoke to communicate with the WCN component. This communication method is simpler than the conventional communication method that the WCN debugging component accesses the device nodes in the kernel layer through a socket. The framework of the above embodiments is simple and clear, reducing unnecessary intermediate layers, improving communication efficiency, and having a good expansibility. For expansion, it is only required to update an API interface function, which also facilitates transplanting.

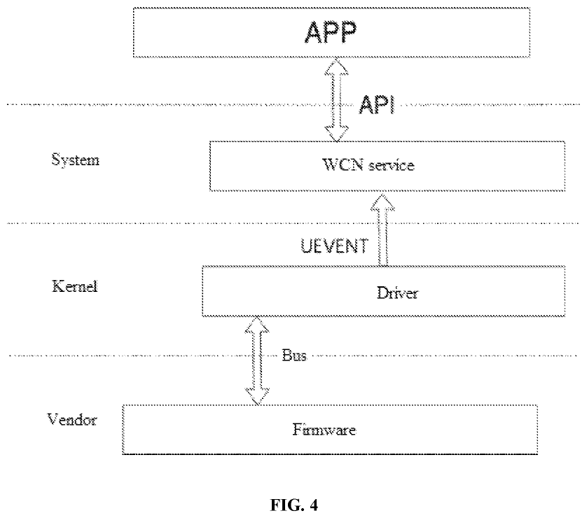

As shown in FIG. 4, a system for recovering from an abnormality of a WCN component of an intelligent device is provided according to an embodiment of the present disclosure. The system includes an AP side component and a WCN component. The AP side component includes a system service, a WCN service, and a driver component. The WCN component includes a WCN firmware. The WCN service includes at least one sub-function service. In some embodiment, the intelligent device is an intelligent phone using an Android system. In some other embodiments, the intelligent device may be an embedded device such as an intelligent speaker. FIG. 4 illustrates an improved architecture based on the general Android system architecture. The system service is represented by the “APP” in FIG. 4 and may further include other system services. The driver component is represented by the “Driver” in FIG. 4, and the WCN firmware is represented by the “Firmware” in FIG. 4. The WCN service is in the system layer of the Android system architecture, and the “Driver” is in the kernel layer of the Android system architecture.

In some embodiments, the WCN service includes four sub-function services, namely a Wi-Fi service, a Bluetooth service, an FM service, and a GPS service.

In some embodiments, the WCN component monitors its own operating state, and in a case that an abnormality of a sub-function component is identified, informs the abnormality to a device node corresponding to the sub-function component in the driver component. The driver component periodically queries the device nodes corresponding to the sub-function components in the driver component at a predetermined time interval. A sub-function in which an abnormal event occurs is identified based on the states of the device nodes. The driver component is further configured to notify an abnormal-sub-function service through an active reporting mechanism after identifying the sub-function in which an abnormal event occurs, where the abnormal-sub-function service is a sub-function service corresponding to the sub-function in which an abnormal event occurs. The abnormal-sub-function service is configured to perform an abnormality recovering process based on the abnormal event by using an internal restarting mechanism of the abnormal sub-function service.

The active reporting mechanism includes a UEVENT mechanism or a Netlink mechanism. In some embodiments, the UEVENT mechanism is adopted, which is simple in implementation and thus is more suitable for the system architecture in the present disclosure.

For example, in some embodiments, in a case that the sub-function in which an abnormal event occurs is the Wi-Fi function, the driver component actively reports to the Wi-Fi service in the system layer through the UEVENT mechanism after identifying that the Wi-Fi function is abnormal, and the Wi-Fi service recovers the Wi-Fi function from the abnormality by using an internal restarting mechanism of the Wi-Fi service based on specific circumstances of the abnormal event. The internal restarting mechanism of the Wi-Fi service properly saves various data related to the Wi-Fi function, thereby avoiding the degradation of system reliability and security caused by, for example, the Wi-Fi service being shut down abnormally.

In the embodiments, the WCND component in the conventional implementation is not used, and the kernel layer actively reports a crash event of the WCN component through the active reporting mechanism. In addition, sub-function components of the WCN service are respectively restarted in corresponding sub-function system partition components, to avoid the degradation of system stability and reliability due to the WCND component abnormally ending a WCN service process.

In the embodiments, the detection of the crash event of the WCN component is performed by the driver component, and the kernel layer actively reports the crash event of the WCN component through the active reporting mechanism. The querying and the reporting are performed inside the driver component, thus improving the access efficiency and security. In this way, the crash event of the WCN component can be identified in a timely manner, avoiding problems of low access efficiency, poor security, poor timeliness, and low accuracy caused by the WCND component accessing the device nodes in the driver component in a cross-component manner for periodically querying.

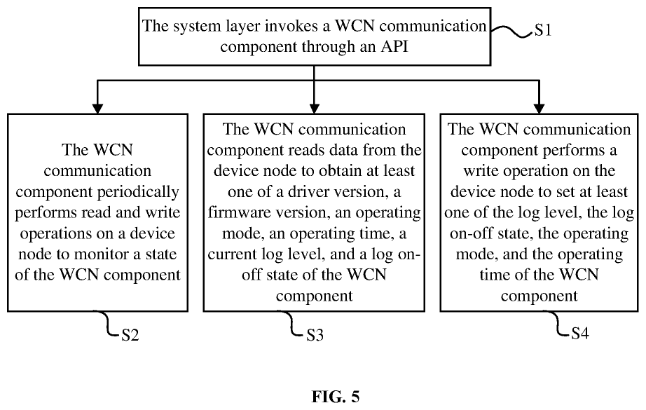

As shown in FIG. 5, a method for communication between an AP component and a WCN component is provided according to an embodiment of the present disclosure. The method is implemented based on the system for communication between an AP component and a WCN component according to the embodiments of the present disclosure.

The method includes the following steps S1 to S4.

In S1, the system layer invokes a WCN communication component through an API.

In S2, the WCN communication component periodically performs read and write operations on a device node to monitor a state of the WCN component.

In S3, the WCN communication component reads data from the device node to obtain at least one of a driver version, a firmware version, an operating mode, an operating time, a current log level, and a log on-off state of the WCN component.

In S4, the WCN communication component performs a write operation on the device node to set at least one of the log level, the log on-off state, the operating mode, and the operating time of the WCN component.

Steps S2, S3, and S4 may not be performed in the listed sequence, and each may be performed after step S1. Depending on the invoking requirements of the system layer, one or more of the steps S2, S3, and S4 are selected to be performed.

In some embodiments, in a case that the operating system of the intelligent device is an Android system, the system layer includes an APP layer and a WCN debugging component. The step S1 that the system layer invokes the WCN communication component through the API may include that the WCN debugging component in the system layer invokes the WCN communication component through the API, and the WCN debugging component transparently transmits result data of the invoking to the APP layer.

In some embodiments, in a case that the operating system of the intelligent device is a non-Android embedded system, the system layer includes an APP layer, and the system layer invoking the WCN communication component through an API may include the APP layer invoking the WCN communication component through the API.

In the embodiments, the conventional WCN debugging component is split and decoupled, so that a function highly related to the communication of the WCN component, i.e., the function of the WCN communication component, is arranged into the lower kernel layer, and an API is provided for invoking by the upper system layer at the AP side. The system layer only invokes the WCN communication component through the API to request monitoring the state of the WCN component. The read access and write access to the device nodes respectively corresponding to the wireless communication functional components are performed by the WCN communication component in the kernel layer, rather than being performed by the cross-component system layer. In this way, the vendor partition component is independent from the system partition component, thereby avoiding cross-component access and preventing the device nodes in the kernel level from being exposed to the outside. The system partition component no longer accesses the vendor partition component through exposed channels, thereby improving the security of the system. Since the WCN communication component and the device nodes are all in the kernel layer, memory access at the AP side is greatly reduced. Compared with cross-component access to the device nodes, the above embodiment can improve communication efficiency and avoid communication congestion.

With the above embodiments, the communication function required by the system layer to monitor the state of the WCN component is realized, and the system layer can acquire and set information related to the WCN component by invoking the WCN communication component. In the above embodiments, the WCN communication component serves as a dynamic library having an interface for the WCND at the system layer to invoke to communicate with the WCN component. This communication method is simpler than the conventional communication method that the WCN debugging component accesses the device nodes in the kernel layer in a cross-component manner. The framework of the above embodiments is simple and clear, reducing unnecessary intermediate layers, improving communication efficiency, and having a good expansibility. For expansion, it is only required to update an API interface function, which also facilitates transplanting.

An intelligent device is provided according to an embodiment of the present disclosure. The intelligent device includes the system for communication between an AP component and a WCN component.

In the system for communication between an AP component and a WCN component used in the intelligent device, the conventional WCN debugging component is split and decoupled so that a function highly related to the communication of the WCN component, i.e., the function of the WCN communication component, is arranged into the lower kernel layer, and an API is provided for invoking by the upper system layer at the AP side. The read access and write access to the device nodes are performed by the WCN communication component in the kernel layer, which prevents the device nodes in the kernel level from being exposed to the outside, thereby improving the security of the system and greatly reducing memory access at the AP side. Compared with cross-component access to the device nodes, the above embodiment can improve communication efficiency and avoid communication congestion. In addition, the framework of the above embodiments is simple and clear, and has a good expansibility, which also facilitates transplanting.

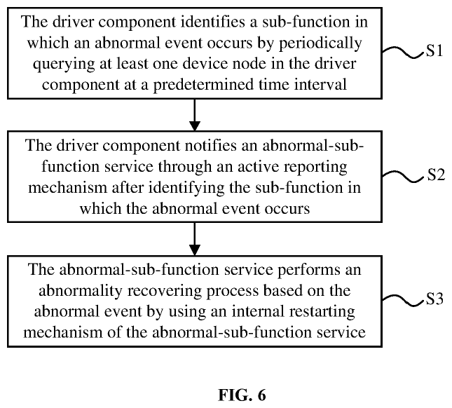

As shown in FIG. 6, a method for recovering from an abnormality of a WCN component of an intelligent device is provided according to an embodiment, which is implemented based on the system for recovering from an abnormality of a WCN component of an intelligent device according to the embodiment of the present disclosure.

The method includes the following steps S1 to S3.

In S1, a driver component identifies a sub-function in which an abnormal event occurs by periodically querying at least one device node in the driver component at a predetermined time interval.

In S2, the driver component notifies an abnormal-sub-function service through an active reporting mechanism after identifying the sub-function in which an abnormal event occurs, where the active reporting mechanism may be a UEVENT mechanism or a Netlink mechanism.

In S3, the abnormal-sub-function service performs an abnormality recovering process based on the abnormal event by using an internal restarting mechanism of the abnormal-sub-function service.

In the embodiment, the WCND component in the conventional implementation is not used, and the kernel layer actively reports a crash event of the WCN component through the active reporting mechanism. In addition, sub-function components of the WCN service are respectively restarted in corresponding sub-function system partition components, to avoid the degradation of system stability and reliability due to the WCND component abnormally ending a WCN service process.

In the embodiment, the detection of the crash event of the WCN component is performed by the lower driver component, and the kernel layer actively reports the crash event of the WCN component through the active reporting mechanism. The querying and the reporting are performed inside the driver component, thus improving the access efficiency and security. In this way, the crash event of the WCN component can be identified in a timely manner, avoiding problems of low access efficiency, poor security, poor timeliness, and low accuracy caused by the WCND component accessing the device nodes in the driver component in a cross-component manner for periodically querying.

An intelligent device is provided according to an embodiment of the present disclosure. The intelligent device includes the system for recovering from an abnormality of a WCN component of an intelligent device according to an embodiment of the present disclosure.

In the embodiment, the WCND component in the conventional implementation is not used, and the kernel layer actively reports a crash event of the WCN component through the active reporting mechanism. In addition, sub-function components of the WCN service are respectively restarted in corresponding sub-function system partition components, to avoid the degradation of system stability and reliability due to the WCND component abnormally ending a WCN service process.

In the embodiment, the detection of the crash event of the WCN component is performed by the lower driver component, and the kernel layer actively reports the crash event of the WCN component through the active reporting mechanism. The querying and the reporting are performed inside the driver component, thus improving the access efficiency and security. In this way, the crash event of the WCN component can be identified in a timely manner, avoiding problems of low access efficiency, poor security, poor timeliness, and low accuracy caused by the WCND component accessing the device nodes in the driver component in a cross-component manner for periodically querying.

Although the specific embodiments are described above, those skilled in the art should understand that the embodiments are only exemplary, and the protection scope of the present disclosure is defined by the appended claims. Various changes or modifications may be made to the embodiments by those skilled in the art without departing from the principle and essence of the present disclosure, and the changes and modifications all fall within the protection scope of the present disclosure.

1. A system for communication between an AP component and a WCN component, applied in an intelligent device, wherein
the WCN component comprises at least one wireless communication functional component, the AP component comprises a system layer and a kernel layer, the kernel layer comprises at least one device node respectively corresponding to the at least one wireless communication functional component, wherein the kernel layer further comprises a WCN communication component, and the system layer is configured to invoke the WCN communication component through an API, to control the WCN communication component to periodically perform read and write operations on the at least one device node to monitor a state of the WCN component.

2. The system according to claim 1, wherein the system layer is further configured to invoke the WCN communication component through the API, to control the WCN communication component to read data from the at least one device node to obtain at least one of a driver version, a firmware version, an operating mode, an operating time, a current log level, and a log on-off state of the WCN component, and/or control the WCN communication component to perform a write operation on the at least one device node to set at least one of a log level, a log on-off state, an operating mode, and an operating time of the WCN component.

3. The system according to claim 2, wherein an operating system of the intelligent device is an Android system, the system layer comprises an APP layer and a WCN debugging component, the WCN debugging component is configured to invoke the WCN communication component through the API, and the WCN debugging component is further configured to transparently transmit result data of invoking to the APP layer.

4. The system according to claim 2, wherein an operating system of the intelligent device is a non-Android embedded system, the system layer comprises an APP layer, and the APP layer is configured to invoke the WCN communication component through the API.

5. The system according to claim 1, wherein the at least one wireless communication functional component comprises a Wi-Fi component, a Bluetooth component, an FM component, and a GPS component.

6. The system according to claim 1, wherein the WCN communication component is a dynamic library.

7. A method for communication between an AP component and a WCN component, wherein the WCN component comprises at least one wireless communication functional component, the AP component comprises a system layer and a kernel layer, the kernel layer comprises at least one device node respectively corresponding to the at least one wireless communication functional component, the kernel layer further comprises a WCN communication component, and
the method comprises:
invoking, by the system layer, the WCN communication component through an API; and
periodically performing, by the WCN communication component, read and write operations on the at least one device node to monitor a state of the WCN component.

8. The method according to claim 7, further comprising:
invoking, by the system layer, the WCN communication component through the API; and
reading, by the WCN communication component, data from the at least one device node to obtain at least one of a driver version, a firmware version, an operating mode, an operating time, a current log level, and a log on-off state of the WCN component, and/or performing, by the WCN communication component, a write operation on the at least one device node to set at least one of a log level, a log on-off state, an operating mode, and an operating time of the WCN component.

9. The method according to claim 8, wherein an operating system of the intelligent device is an Android system, and the system layer comprises an APP layer and a WCN debugging component;
the invoking, by the system layer, the WCN communication component through the API comprises: invoking, by the WCN debugging component, the WCN communication component through the API, and
the method further comprises:
transparently transmitting, by the WCN debugging component, result data of invoking to the APP layer.

10. The method according to claim 8, wherein an operating system of the intelligent device is a non-Android embedded system, the system layer comprises an APP layer, and the invoking, by the system layer, the WCN communication component through the API comprises: invoking, by the APP layer, the WCN communication component through the API.

11. An intelligent device, comprising an AP component and a WCN component, wherein
the WCN component comprises at least one wireless communication functional component, the AP component comprises a system layer and a kernel layer, the kernel layer comprises at least one device node respectively corresponding to the at least one wireless communication functional component, wherein the kernel layer further comprises a WCN communication component, and the system layer is configured to invoke the WCN communication component through an API, to control the WCN communication component to periodically perform read and write operations on the at least one device node to monitor a state of the WCN component.

12. The intelligent device according to claim 11, wherein the system layer is further configured to invoke the WCN communication component through the API, to control the WCN communication component to read data from the at least one device node to obtain at least one of a driver version, a firmware version, an operating mode, an operating time, a current log level, and a log on-off state of the WCN component, and/or control the WCN communication component to perform a write operation on the at least one device node to set at least one of a log level, a log on-off state, an operating mode, and an operating time of the WCN component.

13. The intelligent device according to claim 12, wherein an operating system of the intelligent device is an Android system, the system layer comprises an APP layer and a WCN debugging component, the WCN debugging component is configured to invoke the WCN communication component through the API, and the WCN debugging component is further configured to transparently transmit result data of invoking to the APP layer.

14. The intelligent device according to claim 12, wherein an operating system of the intelligent device is a non-Android embedded system, the system layer comprises an APP layer, and the APP layer is configured to invoke the WCN communication component through the API.

15. The intelligent device according to claim 11, wherein the at least one wireless communication functional component comprises a Wi-Fi component, a Bluetooth component, an FM component, and a GPS component.

16. The intelligent device according to claim 11, wherein the WCN communication component is a dynamic library.
